(19) United States
(12) Patent Application Publication
(10) Pub. No.: US 2005/0232622 A1
(43) Pub. Date: Oct. 20, 2005

(54) Interchangeable lens, camera main body and camera system

(75) Inventors: Tohru Kawai, Kawasaki-shi (JP); Masanori Ishikawa, Saitama-shi (JP); Jun Sugita, Sagamihara-shi (JP); Mitsuru Shinohara, Hokuto-shi (JP); Isamu Go, Utsunomiya-shi (JP); Yuki Nagao, Utsunomiya-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/103,031

(22) Filed: Apr. 11, 2005

(30) Foreign Application Priority Data
Apr. 19, 2004 (JP) 2004-122510

(51) Int. Cl. G03B 13/34

(52) U.S. Cl. 396/133

(57) ABSTRACT

The present invention is a camera system, including an interchangeable lens including a photographing optical system with a focus lens and a camera where the interchangeable lens is detachably mounted to the camera, the camera system configured to include: a focus detection unit for detecting a focus state of the photographing optical system to output a focus signal corresponding to a defocus amount; a controller for outputting a drive signal for driving the focus lens on the basis of the focus signal; a drive mechanism for driving the focus lens on the basis of the drive signal; and a memory for storing information of a drive time pertaining to the drive signal.

### BACKGROUND OF THE INVENTION

1. Field of the Invention

The present invention relates to an interchangeable lens, a camera main body and a camera system, and is more particularly suitable for an imaging apparatus, such as a digital camera, a video camera and a silver film camera, which apparatus includes a focus adjustment device.

2. Description of the Related Art

Conventionally, as one of the focus state detection methods of an automatic focus adjustment device (focus state detection unit) of a camera, there is a focus state detection method adopting the so-called image shift method. In this method, among the light fluxes from a subject, light fluxes having passed through different areas in the exit pupil area of a photographing lens form a subject image severally on a couple of line sensors, and the subject images are photoelectrically converted. Then, an image shift amount, or a relative positional displacement amount of a couple of image signals obtained by the photoelectric conversion, is calculated by a correlation operation. A defocus amount of the photographing lens to the subject is calculated on the basis of the obtained image shift amount. Then, a focusing operation is performed by driving a focus lens on the basis of the defocus amount.

Many focus state detection apparatus adopting the method include a servo control function for driving a focus lens to follow a moving subject such as a vehicle and an electric train.

The servo control function will be described in more detail below.

As shown in FIG. 3, when a switch SW1, which is turned on by a first stroke operation of the release button of a camera, is turned on, a focus state detection unit continuously detects a defocus amount, and updates the drive amount of a focus lens. Moreover, changes of image plane positions obtained on the basis of defocus amounts and drive amounts of the focus lens, both of which have been detected at several times in the past detection, are regarded as a predetermined function of time, and by obtaining the function with a statistical method, a prediction drive of the focus lens is performed.

In a movable mirror type single-lens reflex camera using a focus state detection unit of the image shift method, light does not enter into the focus state detection unit due to its configuration when the mirror is not down (i.e., when the mirror is not located at its normal position). Consequently, no defocus amounts can be detected at that time.

On the other hand, when the mirror is not up (i.e., when the mirror does not retract from a photographing light path), no light enters into an imaging device (e.g., a film, or an image sensor such as a CCD or a CMOS). Consequently, imaging (e.g., exposure of the film, or the photoelectric conversion of the image sensor) cannot be performed. That is, there is a certain fixed amount of lag of a release time lag to a state of exposure from the last time of detection of a focus state by the focus state detection unit. For example, it is supposed that, after the detection of a focus state at a point A of FIG. 3, a switch SW2, which is turned on by a second stroke operation of the release button, is turned on and a release operation (e.g., imaging) is started. In this case, by completing a drive of the focus lens before the imaging by adding a moving body prediction correction amount Δ2 to a defocus amount Δ1 obtained at the time of the last detection of the focus state, it is possible to perform focusing in expectation of the movement of the subject during the release time lag from the time of the last detection of the focus state to the start of the imaging.

Cameras including focus state detection apparatus using this method are disclosed in Japanese Patent Application Laid-Open No. 02-015210 and No. 01-287514.

Generally, a lens drive time for a focus adjustment (a drive time of a focus lens from a defocus state to an in-focus state) changes according to a type of the interchangeable lens, even if a defocus amount obtained by the focus state detection unit is the same. Moreover, in case of a zoom lens, focus responsiveness changes according to a zoom position (focal distance) even if a defocus amount obtained by the focus state detection unit is the same. Consequently, the drive amount of the focus lens changes, therefore the drive time of the focus lens changes. Consequently, if a drive of the focus lens and a start of the mirror up of a camera are performed at the same time, it is possible that the drive of the focus lens is not completed by a start of imaging, and imaging is finished in an unfocused state.

To prevent the above-mentioned state, one approach is to perform the drive of the focus lens and the start of the mirror up of the camera at the same time only when the drive time of the focus lens is sufficiently short. However, it is difficult with such a method to obtain a sufficient effect in view of the type of an interchangeable lens or a zoom lens having a high magnification and the like to be mounted on a camera main body in future.

### SUMMARY OF THE INVENTION

An aspect of the present invention is to overcome the above-described drawbacks.

Another aspect of the present invention is to provide a camera system, capable of suitably controlling an imaging operation according to a drive of a focus lens for focus adjustment to ensure the focus lens is in a focused state before a start of imaging, an interchangeable lens, and a camera, both suitable for the camera system.

Another aspect of the present invention is a camera system, including an interchangeable lens with a photographing optical system having a focus lens and a camera where the interchangeable lens is detachably mounted to the camera, the camera system further comprising a focus detection unit for detecting a focus state of the photographing optical system to output a focus signal corresponding to a defocus amount, a controller for outputting a drive signal for driving the focus lens on the basis of the focus signal, a drive mechanism for driving the focus lens on the basis of the drive signal, and a memory for storing information of a drive time pertaining to the drive signal.

The drive signal in the camera system of the present invention is information indicating a number of drive pulses.

In addition, in the camera system of the present invention, the information of the drive time is information indicating a time necessary for changing the focus lens from a defocus state to an in-focus state corresponding to the drive signal, and the memory stores the previous information of each drive time corresponding to each drive signal.

Another aspect of the present invention is an interchangeable lens for detecting a focus state of a photographing optical system to output a focus lens drive signal corresponding to a defocus amount. The interchangeable lens is detachably mountable on a camera and includes a memory for storing information of a drive time of a focus lens, wherein the drive time pertains to the drive signal, and a controller for outputting the information of the drive time stored in the memory to the camera according to the drive of the focus lens.

The drive signal in the interchangeable lens of the present invention is information indicating a number of drive pulses. Moreover, in the interchangeable lens of the present invention, the information of the drive time is information indicating a time necessary for changing the focus lens from a defocus state to an in-focus state corresponding to the drive signal, and the memory stores the previous information of each drive time corresponding to each drive signal.

Yet another aspect of the present invention is a camera with a detachably mountable interchangeable lens that includes a focus lens, a focus detection unit for detecting a focus state of the focus lens to output a focus signal corresponding to a defocus amount, a controller for outputting a drive signal for driving the focus lens on the basis of the focus signal, and a memory for storing information of a drive time of the focus lens, wherein the drive time pertains to the drive signal.

The drive signal in the camera of the present invention is information indicating a number of drive pulses. Moreover, in the camera of the present invention, the information of the drive time is information indicating a time necessary for changing the focus lens from a defocus state to an in-focus state corresponding to the drive signal, and the memory stores previous information of each drive time corresponding to each drive signal.

Still yet another aspect of the present invention is a camera system including an interchangeable lens with a photographing optical system having a focus lens, and a camera where the interchangeable lens is detachably mounted to the camera, the camera system comprising a focus detection unit for detecting a focus state of the photographing optical system to output a focus signal corresponding to a defocus amount, and a controller on a camera side for outputting a drive signal for driving the focus lens on the basis of the focus signal, an actuator for driving the focus lens, a controller on a lens side for controlling a drive of the actuator according to the drive signal to move the focus lens, a memory for storing information of a drive time pertaining to the drive signal, an imaging device for receiving an optical image formed by the photographing optical system, and a mirror unit for switching light, from the photographing optical system, between entering the focus detection unit and entering the imaging device, wherein the controller on the camera side controls the switching operation of the mirror unit according to the information of the drive time from the memory.

The drive signal in the camera system of the present invention is information indicating a number of drive pulses. Moreover, in the camera system of the present invention, the information of the drive time is information indicating a time necessary for changing the focus lens from a defocus state to an in-focus state corresponding to the drive signal, and the memory stores previous information of each drive time corresponding to each drive signal.

The camera system of the present invention further includes a second memory electrically connected to the controller on the camera side which stores information of an imaging preparation operation time from a start of the switching operation of the mirror unit to a start of imaging of the imaging device, wherein the controller on the camera side controls the switching operation of the mirror unit on the basis of the information of the drive time and the information of the imaging preparation operation time.

In addition, in the camera system of the present invention, the controller on the camera side starts to control the switching operation of the mirror unit to start the switching operation at the same time as the focus lens is driven in a case where the drive time is shorter than the imaging preparation operation time on the basis of the information of the drive time and the information of the imaging preparation operation time. Also, in the camera system of the present invention, in a case where the drive time is longer than the imaging preparation operation time, the controller on the camera side controls the switching operation of the mirror unit to start the switching operation when a remaining drive time of the focus lens becomes equal to the imaging preparation operation time, or when the remaining drive time of the focus lens becomes shorter than the imaging preparation operation time, on the basis of the information of the drive time and the information of the imaging preparation operation time.

In another aspect of the present invention, a camera, including a photographing optical system having a focus lens, the camera comprising a focus detection unit for detecting a focus state of the photographing optical system to output a focus signal corresponding to a defocus amount, an actuator for driving the focus lens, a controller for controlling a drive of the actuator according to a drive signal for driving the focus lens on the basis of the focus signal to move the focus lens, a memory for storing information of a drive time pertaining to the drive signal, an imaging device for receiving an optical image formed by the photographing optical system, and a mirror unit for switching light, from the photographing optical system, between entering the focus detection unit and entering the imaging device, wherein the controller controls the switching operation of the mirror unit according to the information of the drive time from the memory.

The drive signal in the camera of the present invention is information indicating a number of drive pulses. Moreover, in the camera of the present invention, the information of the drive time is information indicating a time necessary for changing the focus lens from a defocus state to an in-focus state corresponding to the drive signal, wherein the memory stores previous information of each drive time corresponding to each drive signal.

The camera of the present invention further includes a second memory electrically connected to the controller, which stores information of an imaging preparation operation time from a start of the switching operation of the mirror unit to a start of imaging of the imaging device, wherein the controller controls the switching operation of the mirror unit on the basis of the information of the drive time and the information of the imaging preparation operation time.

Moreover, in the camera of the present invention, the controller starts to control the switching operation of the mirror unit to start the switching operation at the same time as the drive of the focus lens in a case where the drive time is shorter than the imaging preparation operation time on the basis of the information of the drive time and the information of the imaging preparation operation time.

In addition, in the camera of the present invention, in a case where the drive time is longer than the imaging preparation operation time, the controller controls the switching operation of the mirror unit to start the switching operation when a remaining drive time of the focus lens becomes equal to the imaging preparation operation time, or when the remaining drive time of the focus lens becomes shorter than the imaging preparation operation time on the basis of the information of the drive time and the information of the imaging preparation operation time.

Other features and advantages of the present invention will become apparent to those skilled in the art upon reading of the following detailed description of embodiments thereof when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a camera system of an embodiment of the present invention;

FIG. 2 is a flowchart showing the operation of a focus adjustment of the embodiment of the present invention; and

FIG. 3 is a view showing an example of driving a photographing lens at the time of performing the photographing of a movement subject.

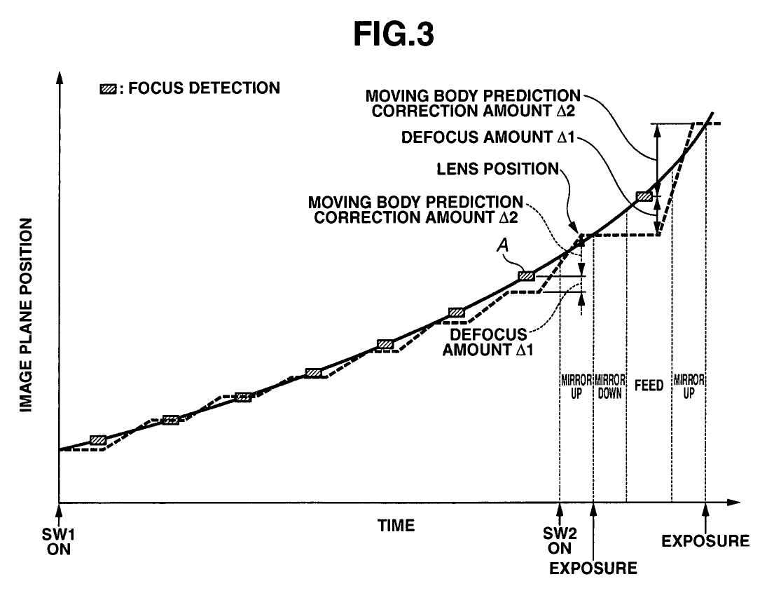

### DETAILED DESCRIPTION OF THE EMBODIMENTS

Embodiments of the invention will be described in detail below with reference to the drawings.

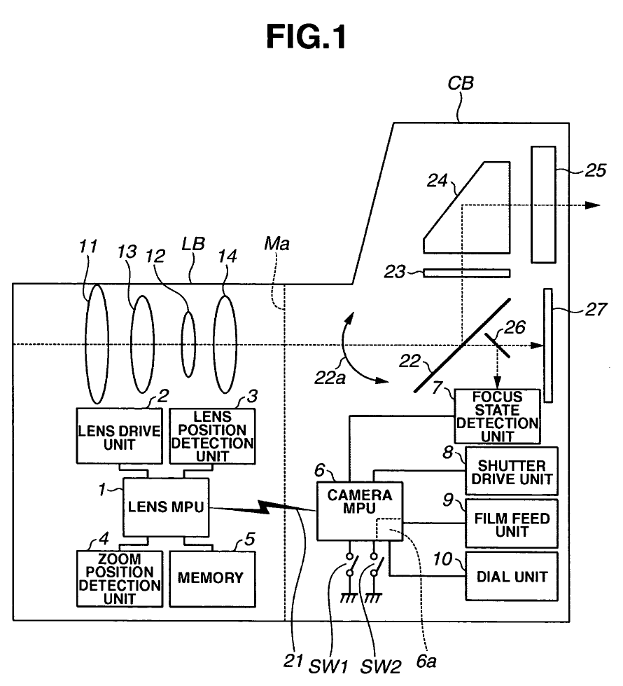

FIG. 1 is a schematic view of the main body of an imaging apparatus (camera system) equipped with a focus state detection unit (focus adjustment device) of an embodiment of the present invention. In FIG. 1, an interchangeable lens type single-lens reflex camera is shown as an example in a block diagram. The present embodiment describes a camera system mounting an interchangeable lens onto the camera main body thereof. However, the camera system (imaging apparatus) may be one having the configuration in which the photographing lens thereof is integrated with the camera main body as one body.

In FIG. 1, reference mark LB denotes the interchangeable lens including a photographing lens (photographing optical system), and reference mark CB denotes the camera main body, both of which are detachably mounted to each other through a mount Ma. The interchangeable lens LB is equipped with a plurality of lenses. Reference numeral 11 denotes a focus lens group (herein a lens group means a lens or a collection of a plurality of lenses), reference numeral 12 denotes an iris, reference numeral 13 denotes a lens group for variable power, and reference numeral 14 denotes a fixed lens group in the variable power.

In the present embodiment, the so-called rear (inner) focus zoom lens, in which a focus lens is located on the image plane side to the variable power lens, can be used as the interchangeable lens LB, in addition to the so-called front focus zoom lens, in which the focus lens group 11 is located in front of the variable power lens 13 (on the subject side) In the case of the rear focus zoom lens, when the zoom lens is zooming, namely when the lens group 13 for variable power is moving, the correction of image screen variations is performed by also moving the focus lens group 11 (and the other movement lenses). The present embodiment is not limited to the zoom lenses described above, and a fixed focal length lens without including the lens group 13 for variable power can be used. Moreover, the number of the lens groups which the photographing lens has may be arbitrary as long as the number is two or more, but a number of the lens groups may be within a range of three groups to seven groups, both inclusive.

Reference numeral 1 denotes a lens micro processing unit (MPU) for performing all of the operations and controls pertaining to the photographing lens. The lens MPU 1 controls, for example, a lens drive unit 2 for driving the focus lens group 11 on the basis of a signal pertaining to a lens drive from a camera MPU 6, which will be described later.

Reference numeral 2 denotes the lens drive unit, which is an actuator for driving the focus lens group 11. Reference numeral 3 denotes a lens position detection unit for detecting a drive amount of the focus lens group 11. Reference numeral 4 denotes a zoom position detection unit for detecting a zoom position (focal distance) by detecting the position of the lens group 13 for variable power. Reference numeral 5 denotes a memory electrically connected to the lens MPU 1. Intrinsic identification information, the information of the focus responsiveness at every zoom position, and the information pertaining to the drive time corresponding to each drive signal of the focus lens group 11 are stored into the memory 5 in a form of a table as the intrinsic information of the interchangeable lens LB.

In an actual photographing lens, an iris drive unit for driving the iris 12 and the like are needed, but the descriptions pertaining to those units are omitted because those units are not directly related to the present embodiment.

Each member from the lens MPU 1 to the memory 5 is included in the interchangeable lens LB.

Reference numeral 6 denotes the camera micro processing unit (MPU) for performing all of the operations and controls pertaining to the camera main body CB. The camera MPU 6 is electrically connected to the lens MPU 1 of the interchangeable lens LB through a signal line 21 of the mount Ma. The interchangeable lens LB and the camera main body CB are configured to perform communications such as the transmission and the reception of various kinds of commands, information and the like between the camera MPU 6 and the lens MPU 1. The lens MPU 1 accesses the memory 5 in response to a request command from the camera MPU 6, and the lens MPU 1 reads out various kinds of information, such as the intrinsic identification information, the zoom position information, and the information of the focus responsiveness of the interchangeable lens LB from each table in the memory 5 to transmit these pieces of information to the camera MPU 6. In particular, when the lens MPU 1 receives a focus lens drive signal (a drive signal corresponding to an amount by which the focus lens group 11 is moved from a defocus position to an in-focus position for focus adjustment) from the camera MPU 6, the lens MPU 1 reads out the information of a drive time corresponding with the drive signal from the memory 5 to transmit the read information of the drive time to the camera MPU 6.

The camera MPU 6 is electrically connected to a memory 6a on the camera side, where the memory 6a is included in the camera MPU 6 or is configured as a separated body, and the camera MPU 6 is configured to be able to access the memory 6a on the camera side. The memory 6a stores the information pertaining to the time of an imaging preparation operation from the start of a mirror-up operation of the main mirror 22 to the start of an imaging operation of an imaging device 27 in the camera main body CB. The camera MPU 6 compares the above-mentioned information of the drive time of the focus lens with the information of the time of the imaging preparation operation, and performs the control of the imaging operation (the start of the mirror-up operation) on the basis of the comparison result. In the case where the time of the imaging preparation operation from the start of the mirror up to the start of the imaging is almost the same as the turning time of the mirror, the time of the imaging preparation operation may be set as the rotating time of the mirror.

In the present embodiment an example is described in which the pieces of information of the drive times (periods of time when the focus lens group 11 is driven from its defocus state to its in-focus state) according to lens drive signals for the focus adjustment of the focus lens group 11 are previously stored in the memory 5 on the side of the interchangeable lens LB. However, the configuration in which those pieces of information are stored in the memory on the side of the camera main body CB may be also adopted. In the case of this configuration, all of the pieces of information as to each of a plurality of interchangeable lenses may be stored in the memory on the camera side, or a configuration may be adopted, in which drive times are obtained by operations on the basis of the intrinsic identification information of an interchangeable lens mounted on the camera main body CB and a previously stored approximation formula.

Reference numeral 7 denotes a focus state detection unit for detecting a focus state of the photographing optical system. The information of a shift amount of an image detected by the focus state detection unit 7 is output to the camera MPU 6. The camera MPU 6 obtains a defocus amount on the basis of the shift amount, and outputs a drive signal corresponding to a drive amount (a drive step amount of the focus lens group 11) of the focus lens group 11 according to the optical information from the memory 5 to the lens MPU 1. In the present embodiment, a focused state determination function for determining whether the defocus amount is within an allowable range (a range allowable as in-focus) is provided in the camera MPU 6.

Reference numeral 8 denotes a shutter drive unit, and reference numeral 9 denotes a film feed unit (which is unnecessary in case of using an image sensor such as a CCD, a CMOS or the like as the imaging device 27). Reference numeral 10 denotes a dial unit for performing the various settings of the camera, such as a shutter speed, an iris value, a photographing mode and the like. Reference mark SW1 denotes the switch which is turned on by the first stroke operation (half depression) of the release button, and reference mark SW2 denotes the switch which is turned on by the second stroke operation (complete depression) of the release button from the state of the first stroke operation.

Reference numeral 22 denotes the main mirror for selectively switching the incidence object of a light flux from the photographing optical system (the interchangeable lens LB) between the focus state detection unit 7 and the imaging device 27 (a photosensitive element such as a film, or an image sensor such as a CCD, a CMOS or the like for performing a photoelectric conversion). The main mirror 22 rotates (a rotation movement around a shaft as its rotation center) in the directions of bidirectional arrow 22a. By rotating the main mirror 22, it is determined whether the light fluxes which have passed through the photographing lens from the subject enter the focus state detection unit 7 or whether the light fluxes enter the imaging device 27. A part of the light fluxes from the subject which have passed through the interchangeable lens LB is reflected by the main mirror 22 to form a subject image on a focusing plate 23. The subject image formed on the focusing plate 23 is observed by an observer through a penta-mirror 24 and an ocular lens 25.

On the other hand, the light flux having passed through a part of the main mirror 22 among the light fluxes from the subject which have passed through the interchangeable lens LB is reflected by a sub-mirror 26 to enter the focus state detection unit 7. The focus state detection unit 7 detects an image shift amount by utilizing a known image shift method.

The main mirror 22 retracts to the outside of the optical path at the time of an imaging operation, and the light having passed through the interchangeable lens LB forms an image of the subject on the imaging device 27. Thus the imaging operation is performed.

By operating the dial unit 10, various photographing modes can be set.

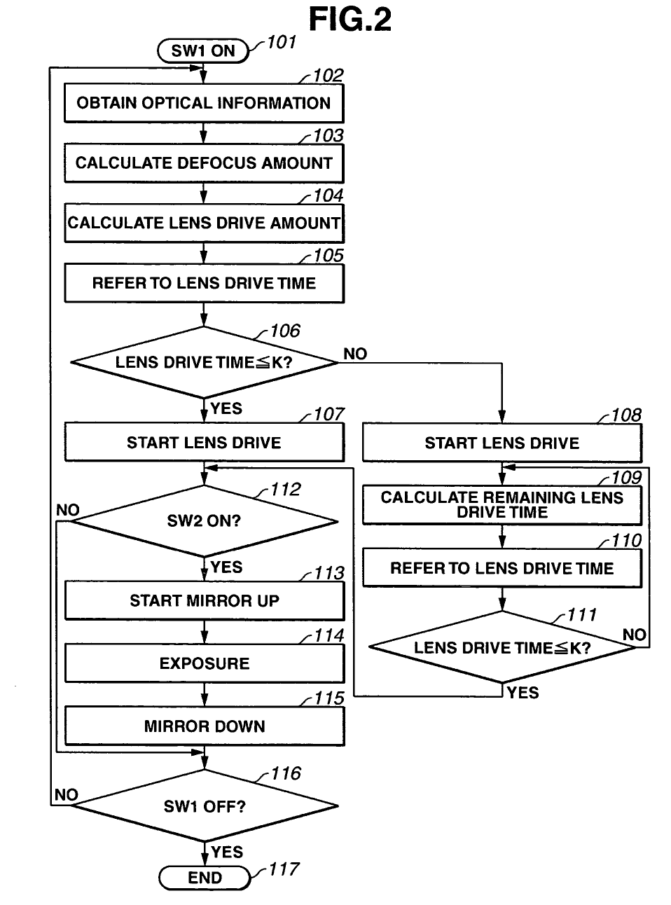

The servo control is described with reference to the flowchart of FIG. 2 with respect to the case where the servo control suitable for photographing a moving subject is set in the present embodiment.

First, when the switch SW1 is turned on in Step 101, the processing of the servo control advances to Step 102, where the camera MPU 6 obtains optical information from the lens MPU 1 of the interchangeable lens LB.

That is to say, the camera MPU 6 obtains the optical information such as responsiveness, a best focusing correction value, a defocus amount per a pulse, and the like, all of which are necessary for automatic focus adjustment, from the photographing lens. The above information is obtained by communicating a signal indicating the transmission of the optical information from the camera MPU 6 to the lens MPU 1. To put it concretely, the encoder of the zoom ring of the photographing lens is electrically divided at even intervals, and the output of the encoder is connected to the zoom position detection unit 4. The lens MPU 1 obtains the present zoom position of the photographing lens from the zoom position detection unit 4, and transmits the information necessary for focus adjustment to the camera MPU 6 by referring to optical information (the information such as the focus responsiveness) in the form of a table according to the zoom positions in the memory 5.

When the camera MPU 6 has obtained the optical information of the interchangeable lens LB, the processing advances to Step 103 to calculate the defocus amount on the basis of the value (the information of a shift) obtained by the focus state detection unit 7.

The calculation of the defocus amount (the difference between the image formation position of the photographing lens and the image plane position of the photographing lens at which a photographing operation should be performed) is performed on the basis of an image shift amount (a positional shift in the direction perpendicular to the optical axis) of two images (subject images) formed by subject light fluxes having passed through two different areas opposed to each other with the optical axis put between them at the position of the exit pupil of the photographing lens. To put it concretely, the light fluxes of the two images pass through the main mirror 22, which is configured as a half mirror unit, and are reflected by the sub-mirror 26 located at a position behind the main mirror 22 to be guided into the focus state detection unit 7 by a not shown focus state detection optical system. The focus state detection unit 7 includes a photoelectric conversion element (not shown), and the camera MPU 6 reads out the signals of the two images. Next, by performing a correlation operation, the camera MPU 6 calculates the image shift amount to obtain a defocus amount D.

After the completion of the calculation of the defocus amount D, the processing advances to Step 104 to calculate a lens drive amount of the photographing lens.

The defocus amount D and the actual lens drive amount of the photographing lens are in a non-linear relation, and the actual lens drive amount is generally approximated by a function corresponding to the defocus amount D. The actual lens drive amount is a number of focus pulses P as a drive waveform to the lens drive unit (actuator) 2 for driving the focus lens group 11.

Because the camera MPU 6 has obtained the optical information (focus responsiveness corresponding to each zoom position) necessary for the conversion to the number of focus pulses P, the camera MPU 6 calculates the operation of the defocus amount D as described above, and performs the conversion to the number of focus pulses P as the lens drive amount. The lens drive amount (the number of focus pulses P), which is a drive signal necessary for focusing, is thus obtained.

When the calculation of the drive signal (lens drive amount) has been completed, the processing advances to Step 105 to refer to a lens drive time. The information of the drive time corresponding to the lens drive signal (drive amount) is read out by referring to the table corresponding to the drive signal in the memory 5 of the interchangeable lens LB. The lens drive time may be also obtained by an operation based on the defocus amount at every execution of the processing.

When the lens drive time has been obtained, the processing advances to Step 106. In Step 106, the camera MPU 6 reads out the information K pertaining to the time of an imaging preparation operation, being the time from the start of the mirror up of the main mirror 22 in the camera main body CB to the start of imaging, from the memory 6a, and compares the information of the lens drive time with the information K of the imaging preparation operation time. When the lens drive time≦the time K, the processing advances to Step 107. In the other cases, the processing advances to Step 108.

When the processing advances to Step 107, the lens drive is started, and the processing proceeds to Step 112.

On the other hand, when the processing advances to Step 108, the lens drive is started, and the processing proceeds to Step 109. In Step 109, the remaining lens drive amount after the lens drive has started is calculated. Then, in Step 110, the information of the lens drive time corresponding to the remaining lens drive amount is referred to from the memory 5 of the interchangeable lens LB.

When the reference of the lens drive time information has been completed, the processing advances to Step 111. In Step 111, the information of the lens drive time and the information K of the time of the imaging preparation operation are again compared. When the lens drive time≦the time K, the processing proceeds to Step 112. In the other cases, the processing returns to Step 109, and the above-mentioned operations are repeated until the lens drive time becomes to be≦the time K.

In Step 112, a determination is made whether the switch SW2 is on or not. When the switch SW2 is on, the processing advances to Step 113. When the switch SW2 is off, the processing advances to Step 116.

In Step 113, the main mirror is turned up, and the processing moves to Step 114. In Step 114, an imaging operation is performed. Next, in Step 115, the main mirror 22 is turned down, and then the processing advances to Step 116.

In Step 116, a determination is made whether the switch SW1 is off or not. If switch SW1 is off, the processing is completed. If the switch SW1 is on, the processing returns to Step 102, and the above-mentioned operations are repeated.

As described above, in the present embodiment, when the lens drive time≦time K and the switch SW2 is on, the main mirror 22 is turned up to start photographing (exposure).

That is to say, the information of the lens drive time and the information of the imaging preparation operation time (a time from the start of the mirror up of the mirror 22 to the start of imaging) are compared. When the lens drive time is shorter than the turning time of the mirror 22, the imaging operation is controlled so that the drive of the focus lens group 11 and the turning of the mirror 22 may start at the same time. When the lens drive time is longer than the imaging preparation operation time (the time from the start of the mirror up of the mirror 22 to the start of imaging), the remaining time necessary for the drive of the focus lens group 11 and the imaging preparation operation time (the time from the start of the mirror up of the mirror 22 to the start of imaging) are compared. Then, rotating the mirror 22 is controlled to start when the remaining time necessary for the drive of the focus lens group 11 becomes equal to the imaging preparation operation time.

In the present embodiment, the described camera system is composed of the camera main body and the interchangeable lens detachable to the camera main body. However, the present embodiment is not limited to such a camera system. For example, the present embodiment may be configured as a camera system in which a lens is integrally built into the camera main body, or as a lens shutter camera. Furthermore, the present embodiment may be configured as a camera for detecting a focus state by means of the light which does not pass through the photographing lens.

According to the above described embodiment, an interchangeable lens, a camera main body and a camera system capable of controlling the photographing operation (imaging preparation operation) according to a lens drive time of a focus lens group necessary for focus adjustment can be achieved.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-122510 filed Apr. 19, 2004, which is hereby incorporated by reference herein.

1. A camera system including an interchangeable lens, including a photographing optical system having a focus lens, and a camera where the interchangeable lens is detachably mounted to the camera, the camera system comprising:
a focus detection unit for detecting a focus state of the photographing optical system to output a focus signal corresponding to a defocus amount;
a controller for outputting a drive signal for driving the focus lens on the basis of the focus signal;
a drive mechanism for driving the focus lens on the basis of the drive signal; and
a memory for storing information of a drive time pertaining to the drive signal.

2. A camera system according to claim 1, wherein the drive signal is information indicating a number of drive pulses.

3. A camera system according to claim 1, wherein the information of the drive time is information indicating a time necessary for changing said focus lens from a defocus state to an in-focus state corresponding to the drive signal, and
wherein the memory stores previous information of each drive time corresponding to each drive signal.

4. An interchangeable lens, detachably mountable on a camera, for detecting a focus state of a photographing optical system to output a focus lens drive signal corresponding to a defocus amount, the interchangeable lens comprising:
a memory for storing information of a drive time of a focus lens, wherein the drive time pertains to the drive signal; and
a controller for outputting the information of the drive time stored in the memory to the camera according to the drive signal of the focus lens.

5. An interchangeable lens according to claim 4, wherein the drive signal is information indicating a number of drive pulses.

6. An interchangeable lens according to claim 4, wherein the information of the drive time is information indicating a time necessary for changing the focus lens from a defocus state to an in-focus state corresponding to the drive signal, and
wherein said memory stores previous information of each drive time corresponding to each drive signal.

7. A camera with a detachably mountable interchangeable lens that includes a focus lens, the camera comprising:
a focus detection unit for detecting a focus state of the focus lens to output a focus signal corresponding to a defocus amount;
a controller for outputting a drive signal for driving the focus lens on the basis of the focus signal; and
a memory for storing information of a drive time of said focus lens, wherein the drive time pertains to the drive signal.

8. A camera according to claim 7, wherein the drive signal is information indicating a number of drive pulses.

9. A camera according to claim 7, wherein the information of the drive time is information indicating a time necessary for changing said focus lens from a defocus state to an in-focus state corresponding to the drive signal, and
wherein the memory stores previous information of each drive time corresponding to each drive signal.

10. A camera system including an interchangeable lens, including a photographing optical system having a focus lens, and a camera where the interchangeable lens is detachably mounted to the camera, the camera system comprising:
a focus detection unit for detecting a focus state of the photographing optical system to output a focus signal corresponding to a defocus amount;
a controller on a camera side for outputting a drive signal for driving the focus lens on the basis of the focus signal;
an actuator for driving the focus lens;
a controller on a lens side for controlling a drive of the actuator according to the drive signal to move the focus lens;
a memory for storing information of a drive time pertaining to the drive signal;
an imaging device for receiving an optical image formed by the photographing optical system; and
a mirror unit for switching light from the photographing optical system between entering the focus detection unit and entering the imaging device,
wherein the controller on the camera side controls the switching operation of the mirror unit according to the information of the drive time from the memory.

11. A camera system according to claim 10, wherein the drive signal is information indicating a number of drive pulses.

12. A camera system according to claim 10, wherein the information of the drive time is information indicating a time necessary for changing the focus lens from a defocus state to an in-focus state corresponding to the drive signal, and
wherein the memory stores previous information of each drive time corresponding to each drive signal.

13. A camera system according to claim 10, the system further comprising:
a second memory electrically connected to the controller on the camera side, the second memory storing information of an imaging preparation operation time from a start of the switching operation of the mirror unit to a start of imaging of the imaging device,
wherein the controller on the camera side controls the switching operation of the mirror unit on the basis of the information of the drive time and the information of the imaging preparation operation time.

14. A camera system according to claim 13, wherein the controller on the camera side starts to control the switching operation of the mirror unit to start the switching operation at the same time as the focus lens is driven in a case where the drive time is shorter than the imaging preparation operation time on the basis of the information of the drive time and the information of the imaging preparation operation time.

15. A camera system according to claim 13, wherein the controller on the camera side controls the switching operation of the mirror unit to start the switching operation in a case where the drive time is longer than the imaging preparation operation time, when a remaining drive time of the focus lens becomes equal to the imaging preparation operation time, or when the remaining drive time of the focus lens becomes shorter than the imaging preparation operation time on the basis of the information of the drive time and the information of the imaging preparation operation time.

16. A camera including a photographing optical system having a focus lens, said camera comprising:
a focus detection unit for detecting a focus state of the photographing optical system to output a focus signal corresponding to a defocus amount;
an actuator for driving said focus lens;
a controller for controlling a drive of the actuator according to a drive signal for driving the focus lens on the basis of the focus signal to move the focus lens;
a memory for storing information of a drive time pertaining to the drive signal;
an imaging device for receiving an optical image formed by the photographing optical system; and
a mirror unit for switching light, from the photographing optical system, between entering the focus detection unit and entering the imaging device,
wherein the controller controls the switching operation of the mirror unit according to the information of the drive time from the memory.

17. A camera according to claim 16, wherein the drive signal is information indicating a number of drive pulses.

18. A camera according to claim 16, wherein the information of the drive time is information indicating a time necessary for changing the focus lens from a defocus state to an in-focus state correspondingly to the drive signal, and
wherein the memory stores previous information of each drive time corresponding to each drive signal.

19. A camera according to claim 16, the camera further comprising:
a second memory electrically connected to the controller, the second memory storing information of an imaging preparation operation time from a start of the switching operation of the mirror unit to a start of imaging of the imaging device,
wherein the controller controls the switching operation of said mirror unit on the basis of the information of the drive time and the information of the imaging preparation operation time.

20. A camera according to claim 19, wherein the controller starts to control the switching operation of the mirror unit to start the switching operation at the same time as the focus lens is driven in a case where the drive time is shorter than the imaging preparation operation time on the basis of the information of the drive time and the information of the imaging preparation operation time.

21. A camera according to claim 19, wherein the controller controls the switching operation of the mirror unit to start the switching operation in a case where the drive time is longer than the imaging preparation operation time, when a remaining drive time of the focus lens becomes shorter than the imaging preparation operation time, or when the remaining drive time of the focus lens becomes shorter than the imaging preparation operation time on the basis of the information of the drive time and the information of the imaging preparation operation time.
